(19) United States
(12) Patent Application Publication
(10) Pub. No.: US 2014/0031023 A1
(43) Pub. Date: Jan. 30, 2014

(54) Communication Device for a Vehicle

(71) Applicant: Bayerische Motoren Werke Aktiengesellschaft, Muenchen (DE)

(72) Inventors: Michael SCHRAUT, Muenchen (DE); Thomas KRAUSS, Muenchen (DE)

(73) Assignee: Bayerische Motoren Werke Aktiengesellschaft, Muenchen (DE)

(21) Appl. No.: 13/953,131

(22) Filed: Jul. 29, 2013

(30) Foreign Application Priority Data
Jul. 30, 2012 (DE) 10 2012 213 328.3

(51) Int. Cl. H04W 8/24

(52) U.S. Cl. CPC H04W 8/245
USPC 455/418

(57) ABSTRACT

A communication device for a vehicle has a programmable memory circuit into which access data of a service provider is programmed for the purpose of establishing communication via one of the communication channels provided by the service provider. The communication device has a transmission and/or receiving device to transmit and receive data via the communication channel. Access data of the service provider intended to be programmed into the programmable memory circuit is received by the transmission and/or receiving device, and made available by the same for the purpose of being programmed into the programmable memory circuit.

### BACKGROUND AND SUMMARY OF THE INVENTION

The invention relates to a communication device for a vehicle, for an exchange of data between the vehicle and a control center. The invention also relates to a vehicle having such a communication device, as well as to a system for carrying out an exchange of data between a transmission and/or receiving station and a vehicle.

Today, vehicles are equipped with a number of communication and navigation functions. The driver can conduct telephone conversations and/or access updated traffic information, for example. In addition, the vehicles can communicate with a control center, or can even be networked with each other via the control center. By way of example, information on traffic jams, road conditions, or weather can be provided by the control center to a vehicle.

For the purpose of transmitting data from the vehicle during a telephone conversation, or for the purpose of transmitting data between the control center and the vehicle, the communication service provider (provider) provides a communication channel. The transmission of data can be carried out via a modem configured in the vehicle. The modem typically obtains the access data of the service provider from a SIM card, to establish a connection via the communication channel of the provider. The SIM card has a memory device for this purpose, in which the access data of the provider is saved. The data transmission is then billed to a customer/driver at the rate which is typically negotiated by the vehicle manufacturer with the service provider.

The SIM card provided by the service provider can be permanently installed in the vehicle. By way of example, it can be soldered into the communication/navigation device of the vehicle, and/or in the control device of the vehicle. However, this has the effect that it is not possible, or is only possible under difficult circumstances, to change the SIM card by simply exchanging the SIM card and thereby switching to another provider—for example by exchanging the entire communication/navigation device and/or the control device. However, a driver or a vehicle manufacturer often may like to change the service provider from time to time, for example when another provider can offer him or her better conditions, or when he or she is in an area in which the network coverage of the current provider is not sufficient, and therefore the quality of the data transmission is unsatisfactory.

It is desirable to provide a communication device for a vehicle which makes it easily possible to switch the service provider of a communication channel via which the exchange of data will take place. In addition, a vehicle should be provided having such a communication device and a system for carrying out an exchange of data between a transmission and/or receiving station and a vehicle.

One embodiment of the communication device for a vehicle, according to the invention has:

a programmable memory circuit for the purpose of programming the access data of a service provider, to establish communication via a communication channel provided by the service provider,

a transmission and/or receiving device for the purpose of transmitting and receiving data via the communication channel,

wherein the transmission and/or receiving device is designed to receive the access data of the service provider, the same being then programmed into the programmable memory circuit, and to make said access data available for programming into the programmable memory circuit.

According to one possible embodiment variant, the communication device can have a simulation circuit for the purpose of simulating a SIM card. The simulation circuit is coupled to the configuration connector and contains the programmable memory circuit. The access data of the service provider which is saved in the programmable memory circuit is provided by the simulation circuit to the transmission and/or receiving device, via a configuration connector of the transmission and/or receiving device. For this purpose, the simulation circuit is connected to the configuration connector of the transmission and/or receiving device. According to one possible embodiment, the simulation circuit can be designed as an FPGA circuit.

A vehicle having a communication device according to the embodiment is described herein.

A system for carrying out an exchange of data between a transmission and/or receiving station and a vehicle has:

a communication device for the vehicle, according to one of the embodiments above, which is arranged in the vehicle,

wherein the transmission and/or receiving station is designed to transmit the access data of the service provider to the vehicle, and

wherein the transmission and/or receiving device of the communication device is designed to receive the access data transmitted by the transmission- and/or receiving station.

The access data received by the transmission and/or receiving device can be programmed into the programmable memory circuit by way of a programming circuit of the communication device. The transmission and/or receiving device then accesses the programmed access data of a service provider and establishes a communication connection via the communication channel provided by this service provider. As such, it is possible to easily switch a provider by new and/or modified access data of another provider being transmitted to the transmission and/or receiving device and written into the memory circuit.

The communication device also has a receptacle device for receiving a SIM card of a provider. This SIM card can be permanently installed in the communication device in the receptacle device, such that the SIM card cannot be exchanged. The SIM card can be soldered in the receptacle device of the communication device, for example. The access data of a provider is saved on the SIM card. The SIM card therefore enables a transmission of data via a communication channel belonging to the provider of the SIM card. If access data of a provider which will be used in the future is intended to be transmitted by the transmission and/or receiving station to the communication device, the data transmission can take place via the communication channel of the provider whose SIM card is permanently installed in the communication device of the vehicle. The SIM card therefore enables an initial connectivity with the transmission and/or receiving station for the purpose of transmitting provider access data to be used in the future.

The transmission of the access data of the provider to be used by the communication device in the future can take place by provisioning over the air. The provisioning involves the access data of the new provider being transmitted to the vehicle by the transmission and/or receiving station—for example, a control center of the vehicle manufacturer.

A plurality of SIM cards can be provided in the transmission and/or receiving station, on which various different provider profiles and/or the access data of these providers are saved. The transmission and/or receiving station can have a control device which selects one of the providers for a future transmission of data from a vehicle, and which transmits the access data of this service provider to the vehicle.

By changing the provider, the vehicle can communicate with all, or at least with some, providers on a continent. The access data of the new service provider is loaded into the programmable memory circuit of the communication device of the vehicle by the transmission and/or receiving station as required.

The transmission and/or receiving station can contain a storage device in which there is a list with various different providers for each country. The location of the vehicle, and particularly the country in which the vehicle is located, is determined via a positioning device of the vehicle. The determined position of the vehicle can be transmitted to the control center. After the position data is evaluated, the transmission and/or receiving station can determine in which country a vehicle is presently located. A provider can be selected from the country-specific list of service providers in the central transmission and/or receiving station, and the access data of the provider can be transmitted to the vehicle and programmed into the programmable memory device of the communication device of the vehicle. If, by way of example, it is not possible to establish a communication connection from the vehicle via the provider at the top of the respective list, the next provider can be selected from the list, and the access data thereof can be transmitted to the vehicle, until the communication device of the vehicle can finally establish a communication connection.

Once a provider has been selected by the communication device for a connection, it may be necessary to carry out a renewed selection of a provider based on altered receiving characteristics, based on a special situation—for example to make an emergency call (ECall)—based on the data content being transmitted and the bandwidth required for the same, based on the time, the network load at that moment, the weather situation at that moment, and also the current condition of the vehicle—for example based on the speed of the vehicle or a driving or parking state of the vehicle. According to a corresponding request of the vehicle, and/or a transmission of vehicle data to the control center, a new service provider can be selected in the transmission and/or receiving station of the control center, to establish a communication connection, and the access data thereof can be transmitted to the communication device of the vehicle.

The selection of the provider can take into account the special situation of a user, for example the existence of partner contracts which can be integrated into the communication system of the vehicle. In addition, a renewed selection of a provider can take place based on a request of the control center. The access data of a provider saved in the programmable memory device of the communication device of the vehicle can be changed and/or updated by the control center at any frequency and any time, by way of provisioning, for example after a new negotiation of roaming agreements, local disruptions, or other events.

The invention is described in greater detail below with reference to figures which show the embodiments of the invention.

### BRIEF DESCRIPTION OF THE DRAWINGS

FIG. 1 shows one embodiment of a transmission path for an exchange of data between a vehicle and a transmission and/or receiving station; and

FIG. 2 shows one embodiment of a communication device for a vehicle.

### DETAILED DESCRIPTION OF THE DRAWINGS

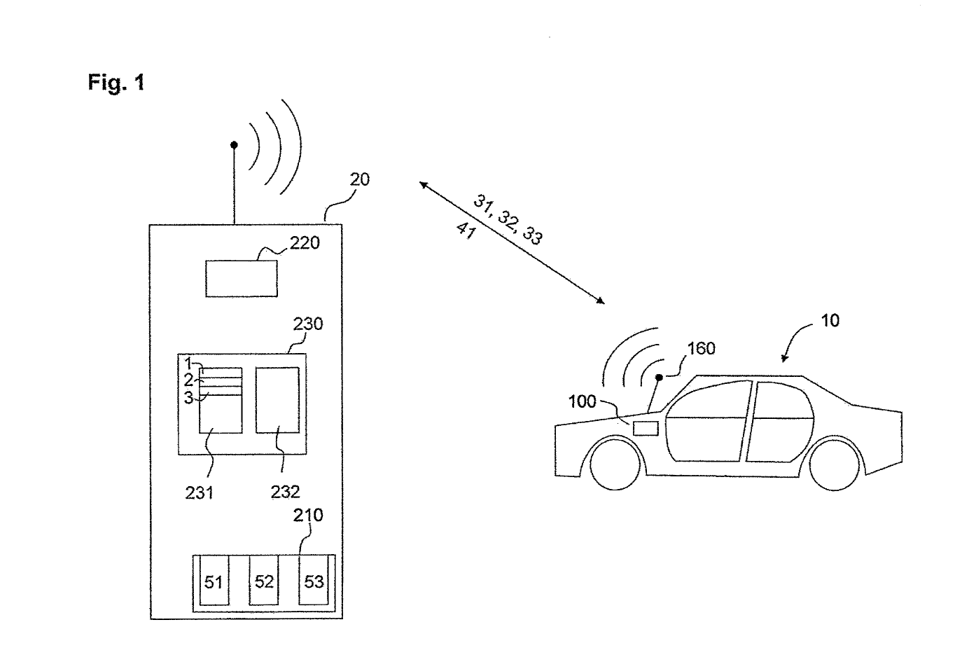

FIG. 1 shows one embodiment of a transmission path for an exchange of data between a vehicle 10 and a transmission and/or receiving station 20 which can be located in a control center of the vehicle provider. The vehicle 10 has a communication device 100 for carrying out a data transmission, for example for carrying out a telephone conversation and for querying navigation data, updated weather data, or other communications from the transmission and/or receiving station 20. The communication device 100 is coupled to an antenna 160 for the purpose of receiving or transmitting data. The data transmission can take place via various different communication channels 31, 32, 33, and/or 41, each of which is provided by different service providers.

The transmission and/or receiving station 20 is designed to transmit the access data of a service provider to the vehicle 10. The transmission and/or receiving station 20 can have a receptacle device 210 for receiving a plurality of chip cards -particularly at least a first and second chip card 51, 52. In the example in FIG. 1, the chip cards 51, 52, and 53 are arranged in the receptacle device 210. The access data of a service provider 1 is saved on the chip card 51, for the purpose of establishing a communication via a communication channel 31 provided by the service provider 1. The access data of another service provider 2 is saved on the chip card 52 for the purpose of establishing a communication via a communication channel 32 provided by the service provider 2, and the access data of yet another service provider 3 is saved on the chip card 53, for the purpose of establishing a communication via a communication channel 33 provided by the service provider 3. The chip cards can be designed as SIM cards of various providers 1, 2, 3.

The transmission and/or receiving station 20 also has a control device 220 for selecting one of the service providers 1, 2, 3, via which the communication device 100 should carry out a future data transmission to the transmission and/or receiving station 20 or to a mobile radio station. For this purpose, the access data of the selected service provider is provided by the control device 220 for the transmission to the communication device 100 of the vehicle 10.

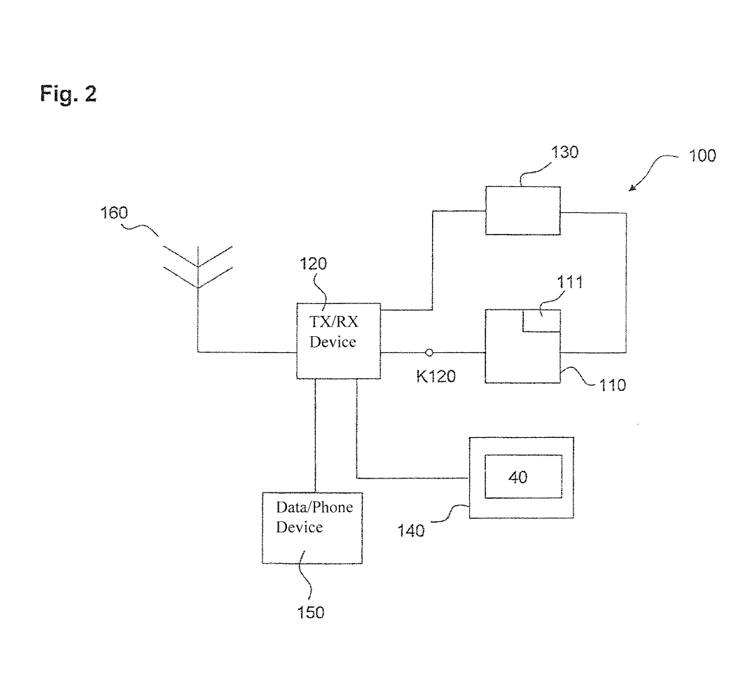

FIG. 2 shows one embodiment of a communication device 100 for the vehicle 10, for the purpose of establishing a communication connection between the vehicle 10 and the transmission and/or receiving station 20, and/or a mobile radio station. The communication device 100 has a programmable memory circuit 111 for programming access data of a service provider, the access data of which is available on the chip cards 51, 52, 53 in the transmission and/or receiving station 20. In addition, the communication device 100 has a transmission and/or receiving device 120 for carrying out a data transmission. The transmission and/or receiving device 120 can be designed as a modem, for example. Data/telephone devices 150 can be connected to the transmission and/or receiving devices 120 in the vehicle. The transmission and/or receiving device 120 is designed to receive the access data of the service providers 1, 2, 3, which access data is intended for programming into the programmable memory circuit 111, and to provide the access data for programming into the programmable memory circuit 111. The transmission and/or receiving device 120 has a configuration connector K120 for relaying the access data of the service provider 1, 2, or 3 saved in the memory circuit 111. The transmission and/or receiving device 120 executes the exchange of data according to the access data present at the configuration connector K120, via the communication channel of the provider for which the access data is saved in the memory circuit 111.

According to one possible embodiment, the communication device 100 has a programming circuit 130 for the purpose of programming the programmable memory circuit 111. The transmission and/or receiving device 120 is designed to provide the programming circuit 130 with the access data of a service provider, which access data is intended for programming into the programmable memory circuit 111. By use of the programming circuit 130, the access data provided by the modem 130 can be programmed into the programmable memory circuit 111.

The transmission and/or receiving device 120 can be designed for the purpose of receiving access data of a service provider at the configuration connector K120. The access data may be provided by a SIM card, for example. The communication device 100 can have a simulation circuit 110 for the purpose of simulating a SIM card, said simulation circuit 110 being coupled to the configuration connector K120 and containing the programmable memory circuit 111. The access data to be programmed into the memory circuit 111, said access data being of the service provider selected in the transmission and/or receiving station 20, is provided to the modem 120 at the configuration connector K120, such that the modem can establish a communication connection via the provider to which the access data belongs. The simulation circuit 110 can be designed as an FPGA circuit, by way of example.

The communication device 100 can also have a receptacle device 140 for receiving a SIM card 40 on which the access data of a further service provider 4 is saved, for the purpose of establishing communication via a communication channel 41 provided by the further service provider 4. The SIM card 40 can be permanently arranged in the receptacle device 140, meaning that it cannot be exchanged. By way of example, a communication connection to the transmission and/or receiving station 20 is established via the service provider 4 when access data of a provider is transmitted by the control center to the vehicle, and should be written into the storage device 111 of the simulation circuit 110.

For the purpose of selecting a provider via which the communication device 100 of the vehicle can carry out a data transmission in the future, the transmission and/or receiving station 20 has a storage device 230 for storing a list 231 in which are saved possible service providers 1, 2, 3 of communication channels. The control device 220 can be designed for the purpose of selecting the service provider to provide a communication channel for the communication device 100 of the vehicle, according to the sequence in which the service providers are saved in the list 231. By way of example, the service provider which is at the top of the list 231 can be selected as the provider for the communication device 100.

The storage device 230 of the transmission and/or receiving station can contain different lists 231, 232 for different countries, with service providers saved therein. The communication device 100 can transmit, for example, a current position of the vehicle 10 to the transmission and/or receiving station 20. The transmission and/or receiving station 20 can receive the position of the vehicle and determine the country in which the vehicle is located according to the position. Next, a suitable service provider can be selected from the list 231, 232 associated with the determined country, to provide a communication channel for the communication device 100 of the vehicle.

The communication device 100 of the vehicle can transmit updated vehicle data which characterizes the condition of the vehicle, particularly the driving state or parked state of the vehicle, and/or the condition of the weather at the location of the vehicle, and/or the content of the data being transmitted, to the transmission and/or receiving station 20. According to the transmitted vehicle data, the control device 220 of the transmission and/or receiving station 20 can select a suitable provider and transmit the access data thereof to the communication device 100. In addition, the selection of a provider can take place in the transmission and/or receiving station 20 according to the receiving characteristics of signals of the provider and/or according to the content of the data being transmitted during the exchange of data, and/or the load on the respective communication channels, and/or the current time.

After the selection of a suitable service provider, the access data thereof is read out of the associated SIM card 51, 52, 53 and transmitted via the standard communication channel 41 to the communication device 100 of the vehicle 10. The transmission and/or receiving station 20 can transmit the access data of the selected provider to the communication device 100 by way of provisioning over the air. The access data of the selected provider is received by the transmission and/or receiving device 120 and written into the storage device 111 of the simulation circuit 110 by the programming circuit 130. The simulation circuit 110 simulates a SIM card for the transmission and/or receiving device 120, with the access data of the selected provider. Then, communication can be established via the communication channel of the selected provider. By way of changing providers, the data transmission from the vehicle can be carried out via the most convenient provider at a certain time or at a certain location.

### LIST OF REFERENCE NUMBERS

1, 2, 3 service provider

10 vehicle

20 transmission- and/or receiving station

31, 32, 33, 41 communication channel

40 chip card, SIM card

51, 52, 53 chip card, SIM card

100 communication device

110 simulation circuit

120 transmission- and/or receiving device

130 programming circuit

140 receptacle device

150 data-/telephone device

160 antenna

210 receptacle device

220 control device

230 storage device

231, 232 list with service providers

1.-15. (canceled)

16. A communication device for a vehicle, comprising:
a programmable memory circuit into which access data of a service provider is programmable, for establishing communication via a communication channel provided by the service provider;
a transmission and/or receiving device configured to transmit and receive data via the communication channel;
wherein the transmission and/or receiving device is configured to receive the access data of the service provider, which access data is to be programmed into the programmable memory circuit, and to make said access data available for programming into the programmable memory circuit.

17. A communication device according to claim 16, further comprising:
a programming circuit for programming the programmable memory circuit;
wherein the transmission and/or receiving device is configured to provide the access data to the programming circuit, and
wherein the programming circuit is configured to program the provided access data into the programmable memory circuit.

18. A communication device according to claim 17, further comprising:
a simulation circuit that simulates a SIM card, wherein the simulation circuit contains the programmable memory circuit;
wherein the transmission and/or receiving device has a configuration connector for relaying the access data of the service provider, and
wherein the access data of the service provider is provided to the transmission and/or receiving device at the configuration connector by the simulation circuit.

19. A communication device according to claim 17, further comprising:
a simulation circuit that simulates a SIM card, wherein the simulation circuit contains the programmable memory circuit; and
wherein the transmission and/or receiving device has a configuration connector for relaying the access data of the service provider,
wherein the access data of the service provider is provided to the transmission and/or receiving device at the configuration connector by the simulation circuit.

20. A communication device according to claim 18, wherein the simulation circuit is an FPGA circuit.

21. A communication device according to claim 18, further comprising:
a receptacle device that receives a SIM card which contains the access data of a further service provider, for establishing communication via a further communication channel provided by the further service provider,
wherein the transmission and/or receiving device is coupled to the receptacle device, and
wherein the transmission and/or receiving device is configured to carry out an exchange of data via the further communication channel of the transmission and/or receiving device.

22. A communication device according to claim 16, further comprising:
a receptacle device that receives a SIM card which contains the access data of a further service provider, for establishing communication via a further communication channel provided by the further service provider,
wherein the transmission and/or receiving device is coupled to the receptacle device, and
wherein the transmission and/or receiving device is configured to carry out an exchange of data via the further communication channel of the transmission and/or receiving device.

23. A communication device according to claim 21,
wherein the transmission and/or receiving device is configured to carry out a data transmission via the further communication channel to receive the access data of the service provider.

24. A communication device according to claim 16,
wherein the transmission and/or receiving device is a modem.

25. A vehicle, comprising:
a communication device for the vehicle, the communication device comprising:
a programmable memory circuit into which access data of a service provider is programmable, for establishing communication via a communication channel provided by the service provider;
a transmission and/or receiving device configured to transmit and receive data via the communication channel;
wherein the transmission and/or receiving device is configured to receive the access data of the service provider, which access data is to be programmed into the programmable memory circuit, and to make said access data available for programming into the programmable memory circuit.

26. A vehicle according to claim 25, further comprising:
a programming circuit for programming the programmable memory circuit;
wherein the transmission and/or receiving device is configured to provide the access data to the programming circuit, and
wherein the programming circuit is configured to program the provided access data into the programmable memory circuit.

27. A communication device according to claim 26, further comprising:
a simulation circuit that simulates a SIM card, wherein the simulation circuit contains the programmable memory circuit;
wherein the transmission and/or receiving device has a configuration connector for relaying the access data of the service provider, and
wherein the access data of the service provider is provided to the transmission and/or receiving device at the configuration connector by the simulation circuit.

28. A communication device according to claim 27, further comprising:
a receptacle device that receives a SIM card which contains the access data of a further service provider, for establishing communication via a further communication channel provided by the further service provider,
wherein the transmission and/or receiving device is coupled to the receptacle device, and
wherein the transmission and/or receiving device is configured to carry out an exchange of data via the further communication channel of the transmission and/or receiving device.

29. A system for carrying out an exchange of data between a transmission and/or receiving station and a vehicle, the system comprising:
a communication device arranged in the vehicle, the communication device comprising:
a programmable memory circuit into which access data of a service provider is programmable, for establishing communication via a communication channel provided by the service provider;
a transmission and/or receiving device configured to transmit and receive data via the communication channel;
wherein the transmission and/or receiving device is configured to receive the access data of the service provider, which access data is to be programmed into the programmable memory circuit, and to make said access data available for programming into the programmable memory circuit;
wherein the transmission and/or receiving station is configured to transmit the access data of the service provider to the vehicle, and
wherein the transmission and/or receiving device of the communication device is configured to receive the access data transmitted by the transmission and/or receiving station.

30. A system according to claim 29, wherein:
wherein the transmission and/or receiving station has a receptacle device for receiving a first and at least one second chip card, wherein access data of a first service provider is saved on the first chip card, for establishing communication via a first communication channel provided by the first service provider, and access data of at least one second service provider is saved on the at least one second chip card for establishing communication via a second communication channel provided by at least one second service provider, and
the transmission and/or receiving station has a control device for selecting the first or the at least one second service provider for the exchange of data with the communication device, and for providing the access data of the selected service provider for the transmission to the communication device.

31. A system according to claim 30, wherein the transmission and/or receiving station is configured to transmit the access data of the selected service provider to the communication device via the further communication channel.

32. A system according to claim 31,
wherein the control device of the transmission and/or receiving station is configured to select the first or the at least one second service provider according to:
(a) receiving characteristics of signals of the first and the at least one second service provider,
(b) content of the data being transmitted during the exchange of data,
(c) a load on the first and second communication channels, and/or
(d) a time.

33. A system according to claim 32, further comprising:
a storage device for storing a list, wherein the first and the at least one second service providers are saved in the list of the storage device of the transmission and/or receiving station, and
wherein the control device of the transmission and/or receiving station is configured to select the first or the at least one second service provider according to a sequence in which the first and the at least one second service providers are saved in the list, to carry out the exchange of data.

34. A system according to claim 33, wherein:
the communication device of the vehicle is configured to transmit vehicle data to the transmission and/or receiving station, said vehicle data characterizing a condition of the vehicle, a condition of weather at a location of the vehicle, and/or a content of the data being transmitted, and
the control device of the transmission and/or receiving station is configured to select the first or the at least one second service provider according to the received vehicle data, to provide the first or second communication channel for the exchange of data.

35. A system according to claim 34, wherein:
different lists of service providers for different countries are saved in the storage device of the transmission and/or receiving station,
the communication device transmits a position of the vehicle to the transmission and/or receiving station, and
the transmission and/or receiving station receives the position of the vehicle, and determines the country in which the vehicle is located based on the position, and selects one of the service providers, to carry out an exchange of data from the list associated with the country.
